(19) United States
(12) Patent Application Publication
(10) Pub. No.: US 2005/0244542 A1
(43) Pub. Date: Nov. 3, 2005

(54) Milk improved by treatment with proteases and methods for its preparation

(75) Inventors: Jorge Florin-Christensen, Pullman, WA (US); Joseph B. Harris, Pullman, WA (US)

Correspondence Address: NOVOZYMES NORTH AMERICA, INC., 500 FIFTH AVENUE, SUITE 1600, NEW YORK, NY, 10110, US

(73) Assignees: Novozymes A/S, Bagsvaerd (DK); Chr. Hansen. A/S, Hoersholm (DK)

(21) Appl. No.: 10/528,550

(22) PCT Filed: May 5, 2003
(86) PCT No.: PCT/US03/14249

§ 371 Date: Mar. 18, 2005

Related U.S. Application Data
(60) Provisional application No. 60/415,651, filed on Oct. 2, 2002.
(60) Provisional application No. 60/420,354, filed on Oct. 22, 2002.
(60) Provisional application No. 60/431,856, filed on Dec. 9, 2002.
(60) Provisional application No. 60/433,704, filed on Dec. 16, 2002.
(60) Provisional application No. 60/435,481, filed on Dec. 20, 2002.
(60) Provisional application No. 60/446,436, filed on Feb. 10, 2003.
(60) Provisional application No. 60/448,322, filed on Feb. 19, 2003.

(51) Int. Cl. A23C 9/12

(52) U.S. Cl. 426/42

(57) ABSTRACT

In one aspect, the present invention provides methods for producing milk by limited proteolysis that is resistant to acid coagulation without negatively affecting the organoleptic properties of the milk. In another aspect, the invention provides methods for increasing the absorbability of calcium in milk to a desired level. In another aspect, the invention provides methods for increasing the viscosity of milk to a desired level. In a further aspect, the invention provides methods for producing acidified milk without coagulation. The methods of the invention comprise the steps of heating milk to a temperature between about 40° C. and about 90° C. and treating the milk with an effective amount of one or more protease. The invention also provides milk that is resistant to acid coagulation, milk with an increased viscosity, stably acidified milk, and products made with the milks of the invention.

### FIELD OF THE INVENTION

The present invention relates to protease-treatment of milk to provide resistance to acid coagulation, increased calcium absorbability, and improved organoleptic properties.

### BACKGROUND OF THE INVENTION

Milk coagulates upon acidification. Acidification of milk occurs naturally after ingestion by humans and other mammals by contact with the acidic medium of the stomach. When milk becomes acidified, the caseins in milk aggregate and form large clumps called the coagulum. The coagulum reduces the nutritional value of milk by sequestering nutrients and impeding their uptake. For example, sequestration of calcium in the coagulum accounts for the limited absorption of calcium in milk.

Thus, there is a need for milk and milk-based products with higher nutritional values, particularly higher calcium absorption. There is also a need for acid coagulation-resistant milk, which can be mixed with acidic foods such as fruit juices. In addition, there is a need for improving the organoleptic properties of milk, particularly defatted milk. The present invention addresses these needs.

### SUMMARY OF THE INVENTION

In a first aspect, the invention comprises methods for producing acid coagulation resistant milk. The methods comprise the steps of heating milk to a temperature between about 40° C. and 90° C. and treating the heated milk with an effective amount of one or more proteases under conditions effective for producing acid coagulation-resistant milk without negatively affecting the organoleptic properties of the milk. The milk used in the methods of the invention may be from any mammalian animal, such as for example antelope, bison, cows, camels, sheep, goat, buffalo, and deer. The milk may be whole milk, reconstituted milk, concentrated milk, partially defatted milk, and nonfat milk. In some embodiments, the milk is ultra-high temperature-treated milk.

The one or more proteases may be any proteases effective to provide acid coagulation-resistant milk without detrimentally affecting the organoleptic properties of milk. Exemplary proteases include alkaline proteases, pancreatin, bromelain, papain, trypsin, proteases from Aspergillus sp., protease secreted by Tetrahymena thermophila, and combinations thereof For example, the one or more proteases may comprise ALCALASE, ESPERASE, NEUTRASE, PROTOMEX, and pancreatic trypsin novo (all from Novozymes, Franklinton, N.C., U.S.A.). Typically, the milk is treated with the one or more proteases at a temperature between about 40° C. and about 90° C. for a period between about 5 seconds and about 12 hours.

In some embodiments, treating the heated milk with one or more proteases comprises the steps of: (a) contacting the milk with ALCALASE or pancreatin at a temperature between about 55° C. and about 70° C. for between about 1 minute and about 15 minutes; and (b) contacting the milk with ALCALASE or pancreatin at a temperature between about 75° C. and about 90° C. for between about 1 minute and about 15 minutes. For example, the heated milk may be contacted with between about 1500 U/L and about 4000 U/L of ALCALASE, or with between about 3000 U/L and 8000 U/L of pancreatin.

In a second aspect, the invention provides methods for increasing the absorbability of calcium in milk. The methods comprise the steps of heating milk to a temperature between about 40° C. and 90° C. and treating the heated milk with an effective amount of one or more proteases under conditions effective for increasing the absorbability of calcium in milk without negatively affecting the organoleptic properties of the milk. The milk used in the methods of the invention may be from any mammalian animal, such as for example antelope, bison, cows, camels, sheep, goat, buffalo, and deer. The milk may be whole milk, reconstituted milk, concentrated milk, partially defatted milk, and nonfat milk. In some embodiments, the milk is ultra-high temperature-treated milk.

The one or more proteases may be any proteases effective to provide acid coagulation-resistant milk without detrimentally affecting the organoleptic properties of milk. Exemplary proteases include alkaline proteases, pancreatin, bromelain, papain, trypsin, proteases from Aspergillus sp., protease secreted by Tetrahymena thermophila, and combinations thereof. Typically, the milk is treated with the one or more proteases at a temperature between about 40° C. and about 90° C. for a period between about 5 seconds and about 12 hours.

In some embodiments, treating the heated milk with one or more proteases comprises the steps of: (a) contacting the milk with ALCALASE or pancreatin at a temperature between about 55° C. and about 70° C. for between about 1 minute and about 15 minutes; and (b) contacting the milk with ALCALASE or pancreatin at a temperature between about 75° C. and about 90° C. for between about 1 minute and about 15 minutes. For example, the heated milk may be contacted with between about 1500 U/L and about 4000 U/L of ALCALASE, or with between about 3000 U/L and 8000 U/L of pancreatin.

In some embodiments, the methods further comprise the step of providing a calcium absorption-enhancing agent to the protease-treated milk. Exemplary calcium absorption-enhancing agents include casein phosphopeptides (CPPs), casein phosphopeptide analogues, lactose, lactose analogues, vitamin D, and vitamin D-related compounds. Thus, the methods may comprise providing CPPs to the milk.

In some embodiments, the absorbability of calcium in protease-treated milk is increased by at least from about 25% to about 400%. In some embodiments, the absorbability of calcium in protease-treated milk provided with a calcium-absorption agent is increased by at least about 50%.

In a third aspect, the invention provides methods for increasing the viscosity of milk. The methods comprise the steps of heating milk to a temperature between about 40° C. and 90° C. and contacting the heated milk with an effective amount of one or more proteases under conditions effective for increasing the viscosity of the milk to a desired level without negatively affecting the organoleptic properties of the milk. The milk used in the methods of the invention may be from any mammalian animal, such as for example antelope, bison, cows, camels, sheep, goat, buffalo, and deer. The milk may be whole milk, reconstituted milk, concentrated milk, partially defatted milk, and nonfat milk. In some embodiments, the milk is ultra-high temperature-treated milk.

The one or more proteases may be any proteases effective to provide acid coagulation-resistant milk without detrimentally affecting the organoleptic properties of milk. Exemplary proteases include alkaline proteases, pancreatin, bromelain, papain, trypsin, proteases from Aspergillus sp., protease secreted by Tetrahymena thermophila, and combinations thereof. Typically, the milk is treated with the one or more proteases at a temperature between about 40° C. and about 90° C. for a period between about 5 seconds and about 12 hours.

In some embodiments, treating the heated milk with one or more proteases comprises the steps of: (a) contacting the milk with ALCALASE or pancreatin at a temperature between about 55° C. and about 70° C. for between about 1 minute and about 15 minutes; and (b) contacting the milk with ALCALASE or pancreatin at a temperature between about 75° C. and about 90° C. for between about 1 minute and about 15 minutes. For example, the heated milk may be contacted with between about 2000 U/L and about 4000 U/L of ALCALASE, or with between about 5000 U/L and 8000 U/L of pancreatin.

In some embodiments, the viscosity of the protease-treated milk is increased by at least about 10%, such as at least about 50%, such as at least about 70%.

In a fourth aspect, the invention provides methods for producing acidified milk without coagulation. The methods comprise the steps of (a) contacting the milk with an effective amount of one or more proteases under conditions effective for producing acid coagulation-resistant milk without negatively affecting the organoleptic properties of the milk; and (b) contacting the acid coagulation-resistant milk with an acidifying agent to produce acidified milk without coagulation. The acidifying agent may any agent that reduces the pH of the milk. For example, the milk may be contacted with an acid or cultured with acid-producing bacteria Exemplary acids useful for the practice of the invention include lactic acid, citric acid, hydrochloric acid, tartaric acid, fumaric acid, citromalic acid, succinic acid, and aspartic acid. Exemplary acid-producing bacteria useful for the practice of the invention include lactic acid-producing bacteria, such as lactobacilli. In some embodiments, the pH of the acidified milk is between about 2 and about 4.

In a fifth aspect, the invention provides protease-treated milk that is resistant to acid coagulation, wherein the milk has similar or improved organoleptic properties as control milk. The acid coagulation-resistant milk may be produced using the methods of the invention described above. Some embodiments provide food products comprising at least about 5% of the acid-coagulation-resistant milk of the invention.

In a sixth aspect, the invention provides protease-treated milk with increased calcium absorbability, wherein the milk has a similar calcium content as control milk. The milk providing increased calcium absorbability may be produced using the methods of the invention described above. Some embodiments provide food products comprising at least about 5% of the milk providing increased levels of calcium absorption of the invention.

In a seventh aspect, the invention provides protease-treated milk with increased viscosity, wherein the milk has a similar fat content as control milk. The milk has similar or improved organoleptic properties compared to control milk. The milk with increased viscosity may be produced using the methods of the invention described above. Some embodiments provide food products comprising at least about 5% of the milk with increased viscosity.

In an eighth aspect, the invention provides milk acidified without coagulation. The acidified milk may be produced using the methods of the invention described above. Some embodiments provide food products comprising at least about 5% of the acidified milk.

### DETAILED DESCRIPTION OF THE PREFERRED EMBODIMENT

Mammalian milk coagulates when acidified. Acidification of milk occurs naturally after ingestion in the acidic environment of the stomach. Acidification also occurs when milk is mixed with acidic food products, such as fruit juices, before ingestion. Coagulation of milk is associated with aggregation of caseins to form a coagulum and is undesirable because it negatively affects the organoleptic properties of the milk and because the coagulum may sequester nutrients and hinder their uptake.

In a first aspect, the invention provides methods for producing acid coagulation-resistant milk without negatively affecting the organoleptic properties of the milk. The methods comprise the steps of heating milk to a temperature between about 40° C. and 90° C. and treating the heated milk with an effective amount of one or more proteases under conditions effective for producing acid coagulation-resistant milk without negatively affecting the organoleptic properties of the milk.

The milk used in the methods of the invention may be from any mammalian animal, such as cows, sheep, goats, bison, antelope, deer and camels. Raw milk, or treated milk, such as pasteurized milk, ultra-high temperature (UHT) treated milk, or homogenized milk, concentrated milk, or reconstituted milk, may be used. Similarly, whole milk, partially defatted milk, and non-fat milk are all suitable for use in the methods of the invention.

In the first step of the methods of this aspect of the present invention, the milk is heated to a suitable temperature. A suitable temperature generally depends on the half-life and the temperature optimum of the selected protease or proteases, as described more fully below. Generally, a suitable temperature for heating the milk is a temperature between about 40° C. and about 90° C. For example, a suitable temperature may be between about 55° C. and about 75° C., such as 62° C. In earlier protocols for producing acid coagulation-resistant milk described in U.S. patent application Publication 2002/0192333, protease was added to the milk prior to heating the milk to a suitable temperature. Such protocols produced acid coagulation resistant milk in about 60% of attempts, as described in EXAMPLE 1. Thus, there was considerable variability and unpredictability in the properties of the protease-treated milk produced in different experiments. According to the present invention, the milk is heated before treating the milk with one or more proteases. This heating step significantly increases the success rate. For example, the success rate may be 98%, that is, about 98% of milk samples treated according to this method become acid coagulation resistant, as described in EXAMPLE 2.

In the second step of the methods of this aspect of the invention, the heated milk is treated with one or more proteases. Useful proteases may be any proteases effective to provide acid coagulation-resistant milk without detrimentally affecting the organoleptic properties of milk. The proteases may be purified proteases or recombinantly-produced proteases. Exemplary proteases that are useful in the methods include, but are not limited to, alkaline proteases (e.g., alkaline proteases from Bacillus subtilis or Bacillus licheniformis), pancreatin, bromelain, papain, trypsin, pancreatin, proteases from Aspergillus sp., protease secreted by Tetrahymena thermophila, and combinations thereof. For example, the one or more proteases may include ALCALASE (2.4 LFG, Novozymes, Franklinton, N.C., U.S.A.), ESPERASE (Type FG, Novozymes), NEUTRASE (Novozymes), PROTAMEX (Novozymes), pancreatin (Sigma Chemical Co., St. Louis, U.S.A.), and recombinant pancreatic trypsin (PTN 6.0 S, Type Saltfree, Novozymes). Typically, the proteases used in the methods of the invention are proteases that are generally regarded as safe (GRAS), as defined in the U.S. Code of Federal Regulations. The amount of protease used generally varies according to factors such as the source of protease used, the treatment conditions such as time, pH, and temperature, as described further below. To ensure reproducible results, the activity of the one or more proteases is generally calibrated using an assay for proteolytic activity prior to their use. Any reliable assay for measuring proteolytic activity may be used. An exemplary assay is described in EXAMPLE 1. The proteases used to treat the milk may be soluble or immobilized on a solid matrix.

Conditions effective for producing acid coagulation-resistant milk without negatively affecting its organoleptic properties may vary according to the specific protease(s) used but may be readily determined by one of skill in the art. For example, effective conditions may be determined by assaying the protease-treated milk for acid coagulation resistance and organoleptic properties. Suitable assays for determining the acid coagulation resistance of milk generally compare the fluid condition of control milk and protease-treated milk after the addition of an acidifying agent, as described in EXAMPLE 1. Thus, acid coagulation resistant milk remains fluid, whereas control milk coagulates after contact with an acidifying agent. Assays for organoleptic properties are standard in the art. For example, organoleptic properties of milk may be evaluated by conducting surveys, as described in EXAMPLE 3.

Conditions effective for producing acid coagulation-resistant milk without negatively affecting its organoleptic properties may also be determined by assaying the degree of hydrolysis of the milk. The degree of hydrolysis is defined as the percentage of peptide bonds cleaved. Generally, the extent of hydrolysis of acid coagulation-resistant milk is between about 0.9% and about 2.5%. Assays for determining the degree of hydrolysis are standard in the art. A suitable assay for determining the extent of hydrolysis is described in EXAMPLE 7. Thus, one skilled in the art may readily determine appropriate conditions for proteolytically treating milk to produce acid coagulation-resistant milk without affecting its organoleptic properties.

Typically, the protease treatment of milk comprises contacting the milk with a standardized amount of one or more proteases at a suitable temperature for a controlled length of time. A suitable temperature may be any temperature at which the selected protease(s) are proteolytically active. Typically, a suitable temperature depends on the temperature optimum and the half-life of the selected protease(s), the concentration of protease(s), and the length of the treatment period. The determination of the temperature optimum and the half-life of a protease may be determined empirically, as is well known in the art. Generally, the protease-treated milk produced according to the methods of the invention contains little if any residual proteolytic activity. Thus, a suitable temperature for treating milk with soluble protease(s) typically provides sufficient proteolytic activity during the protease treatment of the milk and inactivation of the protease by the end of the protease-treatment.

In some embodiments, the milk is contacted with the protease at more than one temperature. For example, the milk may be contacted with the protease at or near the temperature optimum of the selected protease(s) for a suitable period of time, after which the temperature of the contacted milk is raised to a temperature at which the protease(s) are inactivated. An instantaneous increase in temperature may be difficult to achieve under industrial conditions and hydrolysis will continue during the inactivation step. Therefore, in some embodiments, the protease treatment may be performed at a temperature higher than the temperature optimum for the selected protease, whereby the enzyme is inactivated during the treatment.

The time of treatment generally varies according to the concentration of protease(s) and the temperature used. For example, the time of treatment may be shortened by increasing the concentration of protease, or by increasing the temperature used. Generally, the time of treatment is between about 5 seconds and about 12 hours, such as between about 1 minute and 5 hours, such as between 5 minutes and 15 minutes.

An exemplary protease treatment according to this aspect of the invention comprises: (a) heating milk to a temperature between about 58° C. and about 67° C.; (b) contacting the heated milk with between about 1500 U/L and about 4000 U/L of ALCALASE or with between about 4000 U/L and about 8000 U/L of pancreatin; (c) incubating the contacted milk at a temperature between about 58° C. and about 67° C. for between about 1 minute and about 15 minutes; and (d) raising the temperature of the contacted milk to a temperature between about 80° C. and about 90° C. for between about 1 minute and about 15 minutes.

As described above, there is generally little if any residual amount of proteolytic activity present in the milk at the end of the proteolysis treatment. Methods for detecting residual proteolytic activity in the milk are standard in the art. For example, residual proteolytic activity in a protein hydrolysate may be determined by adding a sample of the hydrolysate into a hole in a gel containing casein, N,N-dimethyl casein, and gelatin. Any dissolved active protease will diffuse into the gel and hydrolyze some of the protein, forming a circular disc-shaped opaque zone due to the precipitation of calcium caseinate. The area of the opaque zone is compared to the results of a standard dilution of a protease.

Proteolysis may be terminated by slow heat-denaturation of soluble proteases during the protease treatment, as described above, or by elevating the temperature of milk towards the end of the protease treatment. For example, incubations at about 85° C. for about 10 minutes, or at about 95° C. for about 5 minutes are effective to inactivate ALCALASE or pancreatin. Some soluble proteases may also be inactivated by acidification of the milk. For example, ALCALASE is inactive at pH 4 or below.

For insoluble proteases attached to solid support, proteolysis may be terminated by the physical separation of the protease(s) from the protease-treated milk. Physical separation may include filtration, sedimentation, centrifugation, magnetic separation, and other such procedures. For example, if the immobilized enzyme is attached to an extended surface support, such as a cartridge, proteolysis takes place while the milk contacts such an extended surface and terminates as this contact is interrupted.

The methods of the invention are compatible with continuous flow systems for processing milk, in which heated milk flows slowly through large-diameter pipes of a specified length, such as devices for pasteurization for yogurt production. Moreover, the time periods for incubation may be shortened by adjusting the protease concentration or temperature. Therefore, the methods of the invention are amenable to industrial scale-up.

The methods of this aspect of the invention produce acid coagulation-resistant milk that may be stably acidified to a pH down to about 2, for example by mixing the protease-treated milk with acidifying agents such as acids, acid-producing bacteria, or fruit juices, as described in EXAMPLES 8 and 9. Surprisingly, the degree of hydrolysis of the proteins in the protease-treated milk is fairly low, as described in EXAMPLE 7. Importantly, the methods for producing acid coagulation-resistant milk do not detrimentally affect the organoleptic properties of the milk, as described in EXAMPLES 2 and 3. The acid coagulation resistant milk produced according to the invention is suitable for immediate consumption as fluid milk. Alternatively, it may be mixed with other food products, as described in EXAMPLES 8 and 9. For example, it may be mixed with fruit juices to produce a milk-fruit juice mix.

In a second aspect, the invention provides methods for increasing the nutritional value of milk. For example, the methods of the invention provide higher absorbability of calcium in milk. As used herein, the term “absorbability of calcium” refers to the availability of calcium for absorption by the intestines. Calcium is critical for many physiological functions such as neuro-transmissions, muscle contractions, and glandular secretion. In addition, calcium is an essential component of bones. Many research studies have demonstrated links between dietary calcium intake and diseases such as osteoporosis, arterial hypertension, and colon cancer. Milk is one of the main sources of dietary calcium. However, it has been shown that only about 30% of calcium in milk is bioavailable. A large fraction of the calcium in milk is present as calcium phosphate micelles, stabilized in colloidal suspension by caseins. When milk coagulates, caseins aggregate and trap calcium phosphate micelles in the coagulum. It is known that casein phosphoproteins, formed by proteolytic digestion of caseins, inhibit intra-intestinal precipitation of calcium phosphate and stimulate calcium absorption (Sato et al. (1990) Biochem. Biophys. Acta 1077:413-5; Guegen et al. (2000) J. Am. Coll Nutr. 19:199S-136S). However, such proteolytic digestion of milk generally has detrimental effects on its organoleptic properties, for example by imparting a bitter taste or causing milk clotting.

The methods of the invention produce milk providing higher absorbability of milk calcium without negatively affecting the organoleptic properties of the milk. These methods comprise the steps of: heating milk to a temperature between about 40° C. and about 90° C. and treating the heated milk with an effective amount of one or more proteases under conditions effective for increasing the absorbability of calcium in milk to a desired level without negatively affecting the organoleptic properties of the milk.

The milk used in the methods of this aspect of the invention may be from any mammalian animal, as described above. Similarly, raw milk or treated milk, and milk with different fat contents may be used.

In the first step of the methods, the milk is heated to a suitable temperature. A suitable temperature may be determined as described above for the methods of producing acid coagulation-resistant milk. In the second step, the heated milk is treated with one or more proteases, as described above for the methods of producing acid coagulation-resistant milk.

Conditions effective for increasing the absorbability of calcium in milk without negatively affecting its organoleptic properties may be similar to or overlap with the conditions effective for producing acid coagulation-resistant milk. It is important to note, however, that acid coagulation-resistance is not necessarily sufficient for maximal calcium absorbability according to the methods of the invention, as described further below. Conditions effective for increasing the calcium absorbability in milk without negatively affecting its organoleptic properties may vary according to the specific protease(s) used but may be readily determined by one of skill in the art. For example, effective conditions may be determined by assaying the absorbability of milk calcium and organoleptic properties of the protease-treated milk. There are many suitable assays for determining the absorbability of calcium in milk (see, e.g., Guegen et al. (2000) J. Am. Coil. Nutr. 19:199S-136S), such as comparing the relative amounts of radioactive calcium absorbed by the mouse intestine after ingestion of milk to which traceable amounts of radioactive calcium have been added, as described in EXAMPLES 4 and 5. The absorbability of calcium in milk may also be tested in human subjects, for example by measuring ionized calcium changes or urinary calcium changes after ingestion of milk. Thus, one skilled in the art may readily determine appropriate conditions for proteolytically treating milk to enhance calcium absorbability. Organoleptic properties may be evaluated as described above. Conditions effective for increasing the absorbability of calcium in milk without negatively affecting its organoleptic properties may also be determined by assaying the degree of hydrolysis of the milk, as described above. Generally, the degree of hydrolysis of milk with increased calcium absorbability is between about 0.5% and about 2.5%, such as between about 0.7% and about 2.0%, such as between about 0.9% and about 1.5%.

One exemplary protease treatment according to this aspect of the invention comprises: (a) heating milk to a temperature between about 58° C. and about 67° C.; (b) contacting the heated milk with between about 1500 U/L and about 4000 U/L of ALCALASE or with between about 4000 U/L and about 8000 U/L of pancreatin; (c) incubating the contacted milk at a temperature between about 58° C. and about 67° C. for between about 1 minute and about 15 minutes; and (d) raising the temperature of the contacted milk to a temperature between about 80° C. and about 90° C. for between about 1 minute and about 15 minutes.

The methods for increasing the absorbability of calcium in milk may further comprise providing a calcium absorption-enhancing agent to the milk. Exemplary calcium absorption-enhancing agents comprise casein phosphopeptides, casein phosphopeptide analogues, lactose, lactose analogues, vitamin D, vitamin D-related compounds, or other calcium-enhancing agents (see, e.g., Guegen et al. (2000) J. Am. Coll. Nutr. 19:199S-136S). Calcium absorption-enhancing agents, such as casein phosphopeptides may be added to the milk after the protease treatment, as described in EXAMPLE 5. Alternatively, casein phosphopeptides may be provided to the milk by additional proteolysis of milk. As described above, casein phosphoproteins may be produced by proteolytic digestion of milk.

In some embodiments, the absorbability of calcium in milk produced according to the methods of the invention is at least about 2-fold higher than that of control milk, as described in EXAMPLE 4. In some embodiments, providing casein phosphopeptides to the protease-treated milk increases the absorbability of calcium by at least about 50%, as described in EXAMPLE 5. Thus, according to the methods of the invention, a desired level of increased calcium absorbability may be achieved by treating milk with one or more appropriate proteases and optionally further providing one or more calcium absorption-enhancing agents.

In a third aspect, the invention provides methods for improving the organoleptic properties of milk. For example, the invention provides methods for increasing the viscosity of milk. The methods of this aspect of the invention comprise the steps of heating milk to a temperature between about 40° C. and 90° C. and treating the heated with an effective amount of one or more proteases under conditions effective for increasing the viscosity of milk to a desired level without negatively affecting the organoleptic properties of the milk.

The milk used in this aspect of the methods of the invention may be from any mammalian animal, as described above. Similarly, raw milk or treated milk, and whole milk, low-fat milk, or non-fat milk are all suitable for use in the methods of this aspect of the invention.

In the first step of the methods, the milk is heated to a suitable temperature. A suitable temperature may be determined as described above. In the second step, the heated milk is treated with one or more proteases, as described above for the methods of producing acid coagulation-resistant milk.

Conditions effective for increasing the viscosity of milk to a desired level without negatively affecting the organoleptic properties of the milk are similar to the conditions effective for producing acid coagulation-resistant milk, except that generally higher concentrations of protease are used. Thus, conditions effective for increasing the viscosity of milk to a desired level may vary according to the specific protease(s) used but may be readily determined by assaying the viscosity and other organoleptic properties of the protease-treated milk. The viscosity of milk is generally determined using objective assays, such as the viscosimeter assay described in EXAMPLE 3. However, subjective assays for increased thickness may also be used.

One exemplary protease treatment according to this aspect of the invention comprises: (a) heating milk to a temperature between about 58° C. and about 67° C.; (b) contacting the heated milk with between about 2200 U/L and about 4000 U/L of ALCALASE or with between about 5000 U/L and about 8000 U/L of pancreatin; (c) incubating the contacted milk at a temperature between about 58° C. and about 67° C. for between about 1 minute and about 15 minutes; and (d) raising the temperature of the contacted milk to a temperature between about 80° C. and about 90° C. for between about 1 minute and about 15 minutes.

The methods of the invention may produce milk with variable organoleptic properties, such as mouthfeel, texture, viscosity, and odor, depending on the parameters of the protease treatment. Significantly, this may be achieved without producing bitterness or otherwise negatively affecting the organoleptic properties of the milk. For example, contacting the milk with increasing concentrations of protease produces milk with increasingly higher viscosity, as described in EXAMPLE 6. Accordingly, the use of high protease concentrations may increase the viscosity of the milk to the consistence of cream, as described in EXAMPLE 6. In some embodiments, the methods of the invention increase the viscosity of milk by at least between about 5% and about 70%, such as between about 15% and about 50%. In some embodiments, the methods increase the viscosity by at least about 70%. These increases in thickness or creaminess of milk are accomplished without adding to the fat content of the milk. In addition, the thickened milk resists acid coagulation.

In a fourth aspect, the invention provides methods for producing acidified milk without coagulation. These methods comprises the steps of: (a) treating milk with an effective amount of one or more proteases under conditions effective for producing acid coagulation-resistant milk; and (b contacting the acid coagulation-resistant milk with an acidifying agent to produce acidified milk without coagulation of milk.

The milk used in the methods of this aspect of the invention may be from any mammalian animal, as described above. Similarly, raw milk or treated milk, and milk with different fat contents may be used.

In the first step, milk is treated with an effective amount of one or more proteases under conditions effective for producing acid coagulation-resistant milk as described above. In the second step, the acid coagulation-resistant milk is contacted with an acidifying agent to produce acidified milk that is resistant to acid coagulation. In some embodiments, the acidifying agent may be an acid, as described in EXAMPLE 8. Exemplary acids that are suitable for use in this aspect of the invention include lactic acid, citric acid, hydrochloric acid, tartaric acid, fumaric acid, citromalic acid, succinic acid, and aspartic acid. Other edible organic acids may also be used. The protease-treated milk may also be acidified with fruit juices, such as fruit juice concentrate, or powdered fruit juice. Suitable fruit juices include, but are not limited to, orange juice, lemon juice, pineapple juice, cranberry juice, and kiwi juice. In addition or alternatively, the acid coagulation resistant may be acidified by adding a culture of acid-producing bacteria, such as lactic acid-producing bacteria.

The methods of the invention produce milk that is acidified to a pH between about 2 and about 5.5, such as a pH between about 3.5 and about 4.5, as described in EXAMPLE 8. The acidified milk is stable without coagulation or sedimentation for at least about 10 days.

In a fifth aspect, the invention provides protease-treated milk that is resistant to acid coagulation and has similar or improved organoleptic properties as control milk. As used herein, the term “control milk” refers to milk that has not been treated according to the methods of the invention but is otherwise identical to the protease-treated milk. The acid coagulation-resistant milk may be produced using the methods of the invention described above. Some embodiments provide food products comprising at least about 5% of the acid-coagulation-resistant milk of the invention, as described in EXAMPLE 9.

In a sixth aspect, the invention provides protease-treated milk with increased calcium absorbability and similar or improved organoleptic properties as control milk. The milk providing increased levels of calcium absorption may be produced using the methods of the invention described above. In some embodiments, the protease-treated milk may comprise one or more calcium absorption-enhancing agents. Some embodiments provide food products comprising at least about 5% of the milk providing increased levels of calcium absorption of the invention, as described in EXAMPLE 9.

In a seventh aspect, the invention provides protease-treated milk with increased viscosity and a similar fat content as milk as control milk. The milk with increased viscosity may be produced using the methods of the invention described above. Some embodiments provide food products comprising at least about 5% of the milk with increased viscosity, as described in EXAMPLE 9.

In an eighth aspect, the invention provides milk acidified without coagulation. The acidified milk may be produced using the methods of the invention described above. Some embodiments provide food products comprising at least about 5% of the acidified milk, as described in EXAMPLE 9.

The following examples merely illustrate the best mode now contemplated for practicing the invention, but should not be construed to limit the invention.

### EXAMPLE 1

This Example describes a representative method of the invention for producing acid coagulation-resistant milk in which alkaline protease is added to milk before heating the milk.

The activity of the alkaline protease (ALCALASE, 2.4 LFG, Novozymes, Franklinton, N.C., U.S.A.) was defined using an assay based on the hydrolysis of azocasein, as follows. 0.3 ml of 1% Azocasein (Sigma Chemical Co, Saint Louis, Mo., U.S.A.) in 0.1 M Tris-HC1/10 mM CaCl₂, pH 8.0, was mixed with an equal volume of protease diluted in the same buffer. The mixture was incubated for 30 minutes at 20° C., after which the reaction was stopped by addition of 0.6 ml of ice-cold trichloroacetic acid. After incubating the mixture for 25 minutes at 4° C., the samples were spun at 6,000 rpm for 8 minutes in an Eppendorf centrifuge at 4° C. The absorbance of the supernatants was measured at 340 nm. A unit (U) of activity is defined as the amount of protease activity that causes an increase of 0.1 in A₃₄₀ under the conditions of the assay.

The protocol for treating the milk with ALCALASE was similar to that described in U.S. patent application Publication 2002/0192333. 462 U of ALCALASE were added to 250 ml of low-fat (1.5% fat) UHT milk with vigorous mixing. The mixture of milk and protease was heated to 62° C. in a water bath and incubated at 62° C. for 10 minutes. The mixture was then heated to 85° C. by transferring the container to water bath at 85° C. and incubated at that temperature for a further 10 minutes, after which the mixture was cooled in running water at room temperature.

To test for acid coagulation resistance, an aliquot protease-treated milk and control milk that had undergone the same thermal treatment in the absence of protease were mixed with glacial acetic acid at a ratio of one volume of acetic acid to nine volumes of milk in a 1.5 ml Eppendorf tube. After 10 minutes at room temperature, the tubes were inverted. Acid coagulation-resistant milk remained fluid, while the control milk coagulated into a stiff paste.

Using this protocol, the protease treatment produced acid-coagulation resistant milk from about 60% of the milk samples. The variability was not correlated with the fat content of the milk. Similar results were obtained using full-fat milk or non-fat milk. The protease-treated milk had sensory properties, such as taste, mouthfeel, texture, appearance, odor, and viscosity, that were essentially indistinguishable from control milk.

### EXAMPLE 2

This Example describes a representative method of the invention for producing acid coagulation-resistant milk in which alkaline protease is added to pre-heated milk.

The activity of the ALCALASE was defined using the assay described in EXAMPLE 1. 250 ml of low-fat (1.5% fat) UHT milk in a thin-walled stainless steel container was heated to 62° C. 462 U of ALCALASE were added to the heated milk with vigorous mixing, and the mixture was incubated at 62° C. for 10 minutes. The mixture was then quickly heated to 85° C. by transferring the container-to a water bath at 85° C. and incubated at that temperature for a further 10 minutes, after which the mixture was cooled in running water at room temperature.

To test for acid coagulation resistance, the assay described in EXAMPLE 1 was used. Using this protocol, the protease treatment produced acid-coagulation resistant milk from about 98% of the milk samples. A few milk samples remained sensitive to acid coagulation. These samples acquired acid coagulation resistance after a more stringent heat treatment before the protease treatment, such as that used to produce UHT milk (for example, 138° C. for 4 seconds).

Similar results were obtained using full-fat milk or non-fat milk. The protease-treated milk had sensory properties, such as taste, mouthfeel, texture, appearance, odor, and viscosity, that were essentially indistinguishable from control milk.

### EXAMPLE 3

This Example describes a representative method for producing acid coagulation-resistant milk using pancreatin.

The activity of the pancreatin (Sigma Chemical Co., St. Louis, U.S.A.) was defined using the assay described in EXAMPLE 1. Low-fat UHT milk (1.5% fat) was preheated to about 62° C. and 4400 U/L of pancreatin was added with stirring. The mixture of milk and protease was incubated for 10 minutes at about 62° C. After this incubation period, the temperature was raised to 85° C. and incubated at that temperature for 10 minutes, after which the mixture was cooled in running water at room temperature, as described in EXAMPLE 2.

To test for acid coagulation resistance, the assay described in EXAMPLE 1 was used. Using this protocol, the protease treatment produced acid-coagulation resistant milk from about 98% of the milk samples. A few milk samples remained sensitive to acid coagulation. These samples acquired acid coagulation resistance after a more stringent heat treatment before the protease treatment, such as that used to produce UHT milk (for example, 138° C. for 4 seconds).

Similar results were obtained using full-fat milk or non-fat milk. The protease-treated milk had sensory properties, such as taste, mouthfeel, texture, appearance, odor, and viscosity, that were essentially indistinguishable from control milk

### EXAMPLE 4

This Example describes a representative method for treating milk with proteases to increase the absorbability of calcium in milk.

UHT milk (1.5% fat) was treated with 2590 U/L of ALCALASE or 4400 U/L of pancreatin as described in EXAMPLES 2 and 3. Calcium bioavailability was evaluated using an assay conducted on two-month old CF1 female mice. 10 microliters of a watery solution of [⁴⁵Ca]calcium chloride (1 mCi/ml) was added to 500 microliters of control milk or protease-treated milk. The samples were thoroughly mixed and subjected to one cycle of freezing and thawing to aid equilibration of the radioactive calcium with the different calcium pools present in milk.

Mice were fasted for 12 to 72 hours, during which they were allowed unlimited access to water. After this period, mice were placed in individual cages and offered 50 microliters of milk (1 microcurie of [⁴⁵Ca]calcium chloride) placed in the corner of a plastic box to minimize spilling or undue dispersion of milk in the cage. Mice usually located and completely drank the milk drop within three minutes. An hour later, mice were anaesthetized and killed by exposure to diethyl ether vapors. Their tails were excised, placed in a vial, weighed and radioactivity measured by liquid scintillation.

Administration of protease-treated milk resulted in higher radioactivity in the tails of mice than administration of control milk. Calcium absorption in ALCALASE-treated milk and pancreatin-treated milk was increased by about 25% and 400%, respectively, over control milk. Both the ALCALASE-treated milk and the protease-treated milk were resistant to acid coagulation, as measured by the assay described in EXAMPLE 1.

### EXAMPLE 5

This Example describes a representative method for increasing the absorbability of calcium in milk by treating milk with proteases and providing a calcium absorption enhancing agent to the protease-treated milk.

It has been shown that the addition of calcium absorption-enhancing agents to milk, such as casein phosphoproteins (CPPs), lactose, and vitamin D, or related compounds, stimulates calcium absorption (Guegen et al. (2000) J. Am Coll. Nut. 19:119S-136S). Surprisingly, the increased absorption of calcium in the protease-treated milk produced according to the method described in EXAMPLE 4 was not associated with the appearance of free casein phosphopeptides in the milk. Thus, the absorbability of calcium in control milk and protease-treated milk, with or without added CPPs, was evaluated.

UHT milk (1.5% fat) was treated with ALCALASE as described in EXAMPLE 4. Calcium absorbability was evaluated using the assay described in EXAMPLE 4. The source of CPPs was reconstituted non-fat milk that had been thoroughly digested by 10 mg/L trypsin treatment at 37° C. overnight. 10% of the trypsin-digested milk was added to control milk and to protease-treated milk.

The results of this assay are shown in Table 1. As shown in EXAMPLE 4, administration of protease-treated milk resulted in higher radioactivity in the tails of mice than administration of control milk. Moreover, the enhanced uptake of calcium in ALCALASE-treated milk was further increased by addition of CPPs. In contrast, the addition of CPPs to control milk did not increase calcium uptake.

TABLE 1
Calcium Absorbability in Protease-Treated Milk Including CPPs

| | Radioactivity |
|---|---|
| | (cpm) |
| control milk | 228 |
| control milk + CPPs | 198 |
| ALCALASE-treated milk | 516 |
| ALCALASE-treated milk + CPPs | 780 |

These results confirm that protease-treatment is not sufficient for maximal calcium absorbability. Accordingly, the combination of acid coagulation-resistant milk with agents that stimulate calcium uptake, such as CPPs, can markedly improve calcium absorbability.

### EXAMPLE 6

This Example describes a representative method of the invention for improving the organoleptic properties of milk by treating milk with proteases.

UHT milk (1.5% fat) was treated with between 1850 to 3700 U/L ALCALASE or 4000 to 8000 U/L of pancreatin, using the methods described in EXAMPLES 2 and 3. Milk treated with 1850 U/L of ALCALASE had sensory properties, such as taste, mouthfeel, texture, appearance, odor, and viscosity, that were essentially indistinguishable from control milk, as described in EXAMPLES 1 and 2. The use of increasing amounts of protease improved the sensory properties of milk. For example, the addition of increased amounts of protease resulted in a thickening effect such that the milk became creamier, which is reflected in viscosity measurements using an Ostwald viscosimeter, as show in Table 2.

TABLE 2
Viscosity Values of Protease-Treated Milk

| Protease | Viscosity Value |
|---|---|
| Concentration (U/L) | (Centipoise) |
| 0 | 1.622 |
| 1850 | 1.640 |
| 2220 | 1.662 |
| 3700 | 2.702 |

Increasing the protease concentration to between about 2220 and 2960 U/L of ALCALASE yielded increasingly creamy, fluid milk that resisted acid coagulation. The use of about 3700 U/L of ALCALASE produced milk (créme au lait) that has the thickness and texture of cream, without the fat content of cream, and is acid coagulation-resistant.

The protease treatments did not produce any bitter taste. In fact, improvements in sensory properties were easily perceived in taste tests. For example, 16/18 experienced users preferred milk treated with 2590 U/L of ALCALASE over control milk.

Similar results were obtained using pancreatin, with protein concentrations between 5000 and 7000 U/L producing increasingly creamy milk and 8000 U/L of pancreatin producing créme au lait.

### EXAMPLE 7

This Example describes the extent of hydrolysis of proteins in milk treated according to the methods of the invention.

UHT milk (1.5% fat) was treated with between 1850 to 3700 U/L ALCALASE or 4000 to 8000 U/L of pancreatin, using the methods described in EXAMPLES 2 and 3. The level of hydrolysis of the protease-treated milks was estimated using trinitrobenzenesulfonic acid (TNBS). Total hydrolysis of control milk samples was conducted using hydrochloric vapors at 160° C. for 12 hours to break down peptidic bonds in an aliquot of milk and obtain an evaluation of the total amino groups that can be released upon complete hydrolysis. The degree of protease-catalyzed hydrolysis measured in this way was unexpectedly low, as shown in Table 3.

TABLE 3
Extent of Hydrolysis of Protease-Treated Milk

| ALCALASE | Amino Groups |
|---|---|
| Concentration (U/L) | Hydrolyzed |
| 0 | 0% |
| 1,850 | 0.93% |
| 2220 | 2.18% |
| 3700 | 2.24% |

The percentages of amino groups measured with TNBS in each of the treated milk samples with respect to total amino groups measured in control milk fully hydrolyzed by HCl treatment did not exceed 2.5%. Similar results were obtained with pancreatin-treated milk.

Consistent with these results, protein profiles did not show significant changes between control and protease-treated milk. Analysis of the samples was carried out by gel electrophoresis in the presence of sodium dodecyl sulfate in 12.5% and 10% polyacrylamide gels followed by Coomassie blue staining. These results show that a small degree of hydrolysis can have large effects on the traits of protease-treated milk samples, both regarding sensory properties and resistance to acid coagulation.

### EXAMPLE 8

This Example describes a representative method of the invention for producing acidified milk.

UHT milk (1.5% fat) was treated with protease as described in EXAMPLES 2 and 3. Lactic acid (85%) was added to protease-treated milk samples under constant stirring to about 1.6% (v/v). This process produces a stable preparation of acidified milk with a pH of about 4 that was stable for at least 10 days at 4° C. By adjusting the amount of lactic acid, stable acidified milk samples with a pH of between about 3.5 and 5.5 were prepared.

Other acidifiers, such as HCl or fruit concentrates, were also used to produce stable acidified milk from protease-treated milk. Protease-treated milk acidified with fruit juices, such as powdered orange juice, produced a stable and pleasant-tasting fluid composed essentially of milk. The pH of the acidified milk was brought down close to 2 without resulting in coagulation. The acidified milk was stable without coagulation or sedimentation for at least about 10 days. In contrast, the addition of powdered orange juice of control milk resulted in coagulation at a pH below 4.6.

### EXAMPLE 9

This Example describes methods for producing exemplary food products containing the protease-treated milk of the invention.

Milk Caramel: Milk caramel was made using a traditional recipe. Control milk or ALCALASE-treated (2590 U/L) milk was mixed with 300 g/L sucrose and 2.5% bicarbonate. The mixtures were heated with stirring in a simmering water bath for 3 hours until they acquired a brownish color and considerably increased their viscosity. The milk caramel made an excellent spread and there was no difference in taste or other sensory properties between using control milk or ALCALASE-treated milk.

Drinkable Yogurt: Drinkable yogurt was prepared by inoculating either control milk or ALCALASE-treated (2590 U/L) milk with 10% of a conmmercial drinkable yogurt and incubating the mixtures for 4 hours at 40° C. The pH dropped to about 4.5 in this period of time. The results obtained with protease-treated milk and control milk were similar.

Cream Cheese: Cream cheese was prepared using a traditional Middle Eastern recipe for a product known as labneh. Control milk and ALCALASE-treated (2590 U/L) milk were inoculated with 10% of a commercial solid yogurt and incubated at 40° C. for 4 hours without stirring. The cultures were then collected on cheese cloth and the liquid drained. The resulting semi-solid product was an easily-spread type of cheese, which can be salted and variously flavored, if desired. The results obtained with protease-treated and control milk were similar.

Ice Cream: Ice cream was prepared by mixing two volumes of whole eggs, 2.5 volumes of sucrose, 7 volumes of control milk or ALCALASE-treated (2590 U/L) milk, 3 volumes of whipping cream, and flavoring agents, as desired. The mixture was beaten until thick, then frozen to about −20° C.

Milk-Fruit Juice Drinks: Acidified protease-treated milk was used to prepare stable milk-fruit juice mixes. Frozen fruit juice concentrates are usually diluted with 3 volumes of water prior to consumption. Instead of water, frozen fruit juice concentrate was mixed under constant stirring with 3 volumes of control milk or protease-treated milk acidified with lactic acid to a pH of about 4, prepared as described in EXAMPLE 8, to form a milk-fruit juice mix. The mix prepared with control milk resulted in coagulation of the milk, whereas the mix prepared with the protease-treated milk was stable for at least a month. The addition of stabilizers, such as pectins, to the mix with protease-treated milk was acceptable but generally not required.

While the preferred embodiment of the invention has been illustrated and described, it will be appreciated that various changes can be made therein without departing from the spirit and scope of the invention.

1. A method for producing acid coagulation-resistant milk, comprising the steps of heating milk to a temperature between about 40° C. and 90° C. and treating the heated milk with an effective amount of one or more proteases under conditions effective for producing acid coagulation-resistant milk without negatively affecting the organoleptic properties of the milk.

2. The method of claim 1, wherein the milk is from an animal selected from the group consisting of antelope, bison, cows, camels, sheep, goat, buffalo, and deer.

3. The method of claim 1, wherein the milk is raw milk, pasteurized, or ultra-high temperature-treated milk.

4. The method of claim 1 wherein the milk is selected from the group consisting of whole milk, reconstituted milk, concentrated milk, partially defatted milk, and nonfat milk.

5. The method of claim 1. wherein the one or more proteases are selected from the group consisting of alkaline proteases, pancreatin, bromelain, papain, trypsin, proteases from Aspergillus sp., protease secreted by Tetrahymena thermophila., ALCALASE, ESPERASE, NEUTRASE, PROTAMEX, and combinations thereof.

6. The method of claim 1 wherein the milk is treated with the one or more proteases at a temperature between about 40° C. and about 90° C. for a period between about 5 seconds and about 12 hours.

7. The method of claim 1 wherein treating the heated milk comprises the steps of:
(a) contacting the milk with ALCALASE or pancreatin at a temperature between about 55 CC and about 70° C. for between about 1 minute and about 15 minutes; and
(b) contacting the milk with ALCALASE or pancreatin at a temperature between about 75° C. and about 9 C° C. for between about 1 minute and about 15 minutes.

8. The method of claim 7, wherein the heated milk is contacted with between about 1500 U/L end about 4000 U/L of ALCALASE, OP97PCT

9. The method of claim 7 wherein the milk is contacted with between about 3000 U/L and 8000 U/L of pancreatin.

10. The method of claim 1, wherein the protease-treated milk is acid coagulation resistant down to a pH of about 2.

11. The method of claim 1, wherein the acid coagulation-resistant milk is produced using a continuous flow system.

12. A method for increasing the absorbability of calcium in milk, comprising the steps of heating milk to a temperature between about 40° C. and about 90° C. and treating the heated milk with an effective amount of one 01 more proteases under conditions effective for increasing calcium absorbability without negatively affecting the organoleptic properties of the milk.

13. The method of claim 12, wherein the milk is from an animal selected from the group consisting of antelope, bison, cows, camels, sheep, goat, buffalo, and deer.

14. The method of claim 12, wherein the milk is raw milk, pasteurized or ultra-high temperature-treated milk.

15. The method of claim 12 wherein the milk is selected from the group consisting of whole milk, reconstituted milk, concentrated milk, partially defatted milk, and nonfat milk.

16. The method of claim 12. wherein the one or more proteases are selected from the group consisting of alkaline proteases, pancreatin, bromelain, papain, trypsin, proteases from Aspergillus sp., protease secreted by Tetrahymena thermophila, ALCALASE, ESPERASE, NEUTRASE, PROTAMEX, and combinations thereof.

17. The method of claim 12, wherein treating the heated milk comprises the steps of:
(a) contacting the milk with ALCALASE or pancreatin at a temperature between about 55° C. and about 70 CC for between about 1 minute and about 15 minutes; and
(b) contacting the milk with ALCALASE or pancreatin at a temperature between about 75° C. and about 90 aC for between about 1 minute and about 15 minutes.

18. The method of claim 17, wherein the milk is contacted with between about 1500 U/L and about 4000 U/L of ALCALASE.

19. The method of claim 17, wherein the milk is contacted with between about 3000 U/L and 8000 U/L of pancreatin.

20. The method of claim 12, wherein the calcium absorbability in milk is increased using a continuous flow system.

21-57. (canceled)
